(19) United States
(12) Patent Application Publication
(10) Pub. No.: US 2019/0373920 A1
(43) Pub. Date: Dec. 12, 2019

(54) SAFFRON BEVERAGE FORMULATIONS

(71) Applicant: Yass Vossough GRAYELI, New York, NY (US)

(72) Inventor: Yass Vossough GRAYELI, New York, NY (US)

(21) Appl. No.: 16/434,728

(22) Filed: Jun. 7, 2019

Related U.S. Application Data
(60) Provisional application No. 62/682,225, filed on Jun. 8, 2018.

(51) Int. Cl. A23L 2/56; A23L 2/02; A23L 2/60

(52) U.S. Cl. CPC A23L 2/56; A23V 2002/00; A23L 2/60; A23L 2/02

(57) ABSTRACT

The present disclosure relates to beverages containing saffron as well as methods of manufacturing the same. The saffron beverages may include: (a) saffron particles in an amount of about 0.001 to about 1 wt. %, wherein the saffron particles have an average particle size of less than 2 mm; (b) a black pepper extract in an amount of about 0.001 to about 1 wt. %; and (c) water, wherein the saffron beverage has a pH of about 2 to about 5 and all weight percentages are based on the total weight of the saffron beverage.

### CROSS-REFERENCE

This application claims priority to U.S. Provisional Patent Application No. 62/682,225, filed on Jun. 8, 2018, entitled “SAFFRON INFUSED BEVERAGE FORMULATION,” the entirety of which is herein incorporated by reference.

### TECHNICAL FIELD

The present disclosure relates to beverages infused with saffron as well as methods of manufacturing the same.

### BACKGROUND

Currently various types of beverages and drinks are commercially available for consumers to purchase and consume such as energy drinks, vitamin waters, etc. These beverages have various compositions with different ingredients and associated benefits (health benefits).

### SUMMARY OF THE INVENTION

Aspects of the instant disclosure relate to beverages containing saffron as well as methods for manufacturing such beverages. The saffron beverages may be infused with saffron or contain particles of saffron. The saffron beverages disclosed herein may advantageously provide consumers with improved mood; reduced adverse effects of hangovers; detoxification benefits, including enhanced antioxidant enzymes; improved cardiovascular health; reduced stress; reduced inflammation; and improved skin health.

According to a first aspect of the disclosure, provided is a saffron beverage including: (a) saffron particles in an amount of about 0.001 to about 1 wt. %, wherein the saffron particles have an average particle size of less than 2 mm; (b) a black pepper extract in an amount of about 0.001 to about 1 wt. %; and (c) water, wherein the saffron beverage has a pH of about 2 to about 5 and all weight percentages are based on the total weight of the saffron beverage.

In accordance with a second aspect of the disclosure, provided is a saffron infused beverage including: (a) about 0.001 to about 1 wt. % of a concentrate, extract, or mixture thereof derived from saffron stigmas; (b) black pepper extract in an amount from about 0.001 to about 1 wt. %; and (c) water, wherein the beverage has a pH of about 2 to about 5, and wherein all weight percentages are based on the total weight of the saffron beverage.

According to a third aspect of the disclosure, a method for producing a saffron beverage includes the steps of: (a) grinding stigmas of the saffron flower to obtain saffron particles; (b) mixing the saffron particles with black pepper or an extract thereof with a solvent to obtain a mixture, the solvent comprising water; (c) heating the mixture, such that the mixture has a temperature of 180° F. or more for at least 1 minute; and (d) obtaining a pH for the mixture of about 2 to about 5.

In accordance with a fourth aspect of the disclosure, provided is a composition for saffron beverages including: (a) saffron particles in an amount of about 1 to about 90 wt. %; and (b) a black pepper extract in an amount of about 0.1 to about 60 wt. %, wherein the composition has less than 5 wt. % water and wherein all weight percentages are based on the total weight of the saffron beverage.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a schematic of the three stigmas of a saffron flower;

FIG. 2 is a formulation of one example saffron infused beverage, according to one aspect of the present disclosure;

FIG. 3 is a formulation of another example saffron infused beverage, according to one aspect of the present disclosure; and

FIG. 4 is a formulation of a further example saffron infused beverage, according to one aspect of the present disclosure.

### DETAILED DESCRIPTION

Various example embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of saffron beverages and methods for manufacturing such saffron beverages, as well as their related results according to the example embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by combinations particularly pointed out in the appended claims. These and other features of the disclosure will become more fully apparent from the following description and appended claims, or can be learned by the practice of the principles set forth herein.

Aspects of the present disclosure relate to beverages infused saffron as well as methods for manufacturing such beverages. Saffron beverages, as used herein, refer to beverages that are infused with saffron, e.g., by containing particles of saffron or by containing an extract and/or concentrate obtained from saffron. Without being limited to any particular theory, the inventor discovered that several of the benefits derived from the consumption of saffron are enhanced by saffron beverages containing certain amounts of saffron and black pepper extracts, as well as a pH range as discussed herein. Moreover, it is believed that the methods described herein produce saffron beverages having improved saffron potency.

The saffron beverages typically have a pH of about 2 to about 5 and comprise:
(a) particles, concentrate, and/or extract of saffron in an amount ranging from about 0.001 to about 1 wt. %;
(b) black pepper extract in an amount of about 0.001 to about 1 wt. %; and
(c) water, wherein all weight percentages are based on the total weight of the saffron beverage.

The saffron beverages include an amount of saffron generally ranging from about 0.05 to 5 wt. %, based on the total weight of the saffron beverage. For example, saffron may be present in the saffron beverage in an amount of about 0.005 to about 5 wt. %, about 0.005 to about 4.0 wt. %, about 0.005 to about 3.0 wt. %, about 0.005 to about 2.5 wt. %, about 0.005 to about 2.0 wt. %, about 0.005 to about 1.5 wt. %, about 0.005 to about 1.25 wt. %, about 0.005 to about 1.0 wt. %, about 0.005 to about 0.85 about 0.005 to about 0.75 wt. %; about 0.001 to about 5 wt. %, about 0.01 to about 4.0 wt. %, about 0.01 to about 3.0 wt. %, about 0.01 to about 2.5 wt. %, about 0.01 to about 2.0 wt. %, about 0.01 to about 1.5 wt. %, about 0.01 to about 1.25 wt. %, about 0.01 to about 1.0 wt. %, about 0.01 to about 0.85, about 0.01 to about 0.75 wt. %; 0.05 to about 5 wt. %, about 0.05 to about 4.0 wt. %, about 0.05 to about 3.0 wt. %, about 0.05 to about 2.5 wt. %, about 0.05 to about 2.0 wt. %, about 0.05 to about 1.5 wt. %, about 0.05 to about 1.25 wt. %, about 0.05 to about 1.0 wt. %, about 0.05 to about 0.85, about 0.05 to about 0.75 wt. %; about 0.1 to about 5 wt. %, about 0.1 to about 4.0 wt. %, about 0.1 to about 3.0 wt. %, about 0.1 to about 2.5 wt. %, about 0.1 to about 2.0 wt. %, about 0.1 to about 1.5 wt. %, about 0.1 to about 1.25 wt. %, about 0.1 to about 1.0 wt. %, about 0.1 to about 0.85, about 0.1 to about 0.75 wt. %; about 0.2 to about 5 wt. %, about 0.2 to about 4.0 wt. %, about 0.2 to about 3.0 wt. %, about 0.2 to about 2.5 wt. %, about 0.2 to about 2.0 wt. %, about 0.2 to about 1.5 wt. %, about 0.2 to about 1.25 wt. %, about 0.2 to about 1.0 wt. %, about 0.2 to about 0.85, about 0.2 to about 0.75 wt. %; about 0.3 to about 5 wt. %, about 0.3 to about 4.0 wt. %, about 0.3 to about 3.0 wt. %, about 0.3 to about 2.5 wt. %, about 0.3 to about 2.0 wt. %, about 0.3 to about 1.5 wt. %, about 0.3 to about 1.25 wt. %, about 0.3 to about 1.0 wt. %, about 0.3 to about 0.85, or about 0.3 to about 0.75 wt. %, based on the total weight of the saffron beverage.

The saffron beverage may be infused with saffron by containing particles of saffron or by being infused with an amount of concentrate and/or extract obtained from saffron. The saffron particles, if present in the saffron beverage, may have an average particle size of 5 mm or less. In some instances, the saffron particles have an average size of 2 mm or less, such as 4 mm or less, 3 mm or less, 2 mm or less, 1 mm or less, 0.5 mm or less, or 0.25 mm or less.

Additionally or alternatively, the saffron beverage may be infused with an amount of saffron concentrate or saffron extract. Preferably, the saffron concentrate and/or saffron extract contain a full-spectrum of saffron compounds. As used herein, a full-spectrum of saffron compounds refers to all or essentially all of the compounds that are obtained from saffron using conventional extraction methods, such as those using ethanol, water, polar solvents, etc. Without being bound by any particular theory, it is believed that a full-spectrum of saffron compounds may enhance several of the benefits associated with saffron consumption. Accordingly, in some instances, the saffron beverages include all or essentially of the saffron compounds that have a physiological effect on a consumer. For example, the saffron beverage may be infused with a saffron concentrate and/or extract including one or more compounds selected from crocetin, crocins, picrocrocins, safranal, and mixtures thereof.

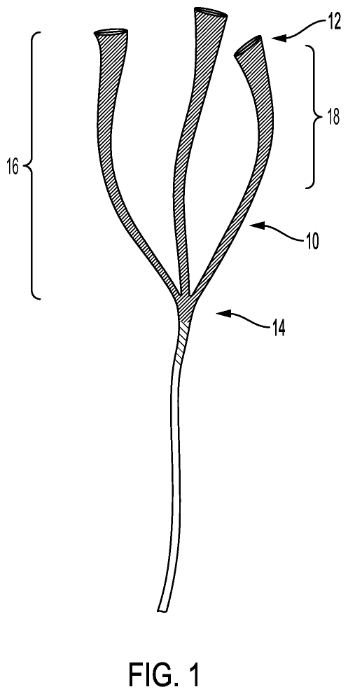

The particles, concentrate, and/or extract of saffron used for infusing the saffron beverage are preferably derived from the stigmas of the saffron flower. As illustrated in FIG. 1, the saffron beverage may be infused with particles, extracts, and/or concentrate derived from a portion of the saffron flower stigmas 10 extending from the tip end 12 of the stigmas 10 to a middle portion 14 of the stigmas 10. In at least one instance, the saffron particles, concentrate, and/or extract are derived from the top half section 16 or the top quarter section 18 of the saffron stigmas. In other instances, the saffron particles, concentrate, and/or extract is derived from the sargol section of the saffron stigmas 10. The saffron used to infuse the saffron beverage may be solely derived from the portion of the saffron flower stigmas 10 extending from a middle portion 14 to the tip end 12 of the saffron flower stigmas 10.

The saffron beverages include black pepper or an extract thereof in an amount typically ranging from about 0.001 to about 1 wt. %, based on the total weight of the saffron beverage. For example, the amount of black pepper or an extract thereof present in the saffron beverage may range from about 0.001 to about 4.0 wt. %, about 0.001 to about 3.0 wt. %, about 0.001 to about 2.5 wt. %, about 0.001 to about 2.0 wt. %, about 0.001 to about 1.5 wt. %, about 0.001 to about 1.25 wt. %, about 0.001 to about 1.0 wt. %, about 0.001 to about 0.75 wt. %; about 0.002 to about 4.0 wt. %, about 0.002 to about 3.0 wt. %, about 0.002 to about 2.5 wt. %, about 0.002 to about 2.0 wt. %, about 0.002 to about 1.5 wt. %, about 0.002 to about 1.25 wt. %, about 0.002 to about 1.0 wt. %, about 0.002 to about 0.75 wt. %; about 0.01 to about 4.0 wt. %, about 0.01 to about 3.0 wt. %, about 0.01 to about 2.5 wt. %, about 0.01 to about 2.0 wt. %, about 0.01 to about 1.5 wt. %, about 0.01 to about 1.25 wt. %, about 0.01 to about 1.0 wt. %, about 0.01 to about 0.75 wt. %; from about 0.05 to about 4.0 wt. %, about 0.05 to about 3.0 wt. %, about 0.05 to about 2.5 wt. %, about 0.05 to about 2.0 wt. %, about 0.05 to about 1.5 wt. %, about 0.05 to about 1.25 wt. %, about 0.05 to about 1.0 wt. %, about 0.05 to about 0.75 wt. %; from about 0.1 to about 4.0 wt. %, about 0.1 to about 3.0 wt. %, about 0.1 to about 2.5 wt. %, about 0.1 to about 2.0 wt. %, about 0.1 to about 1.5 wt. %, about 0.1 to about 1.25 wt. %, about 0.1 to about 1.0 wt. %, or about 0.1 to about 0.75 wt. %, based on the total weight of the saffron beverage.

The black pepper extract may include piperine and, optionally, other compounds obtained from black pepper. For example, the black pepper extract may include piperine and optionally bioperine. In some example embodiments, however, the black pepper extract of the saffron beverage consists of or consists essentially of piperine.

In some instances, the saffron beverages are formulated such that the ratio of saffron to black pepper or an extract thereof is in the range of 150:1 to 20:1. For example, the ratio of saffron to black pepper or an extract thereof in the saffron beverage may range from 200:1 to 5:1, 175:1 to 10:1, 150:1 to 20:1, 125:1 to 25:1, 100:1 to 30:1, 90:1 to 35:1, 80:1 to 40:1, 75:1 to 45:1, or 70:1 to 50:1.

The saffron beverages may also include one or more non-saffron juices, concentrates, or extracts obtain from, e.g., fruits, nuts, vegetables, berries, etc., in an amount typically from about 0.01 to about 50 wt. %, based on the total weight of the saffron beverage. For example, the one or more non-saffron juices, concentrates, or extracts may be present in an amount from about 0.01 to about 50 wt. %, about 0.01 to about 40 wt. %, about 0.01 to about 30 wt. %, about 0.01 to about 25 wt. %, about 0.01 to about 20 wt. %, about 0.01 to about 15 wt. %, about 0.01 to about 10 wt. %, about 0.01 to about 8 wt. %, about 0.01 to about 6.0 wt. %, about 0.01 to about 4.0 wt. %, about 0.01 to about 3.0 wt. %, about 0.01 to about 2.5 wt. %, about 0.01 to about 2.0 wt. %, about 0.01 to about 1.5 wt. %, about 0.01 to about 1.25 wt. %, about 0.01 to about 1.0 wt. %, about 0.01 to about 0.75 wt. %; from about 0.05 to about 50 wt. %, about 0.05 to about 40 wt. %, about 0.05 to about 30 wt. %, about 0.05 to about 25 wt. %, about 0.05 to about 20 wt. %, about 0.05 to about 15 wt. %, about 0.05 to about 10 wt. %, about 0.05 to about 8 wt. %, about 0.05 to about 6.0 wt. %, about 0.05 to about 4.0 wt. %, about 0.05 to about 3.0 wt. %, about 0.05 to about 2.5 wt. %, about 0.05 to about 2.0 wt. %, about 0.05 to about 1.5 wt. %, about 0.05 to about 1.25 wt. %, about 0.05 to about 1.0 wt. %, about 0.05 to about 0.75 wt. %; from about 0.5 to about 50 wt. %, about 0.5 to about 40 wt. %, about 0.5 to about 30 wt. %, about 0.5 to about 25 wt. %, about 0.5 to about 20 wt. %, about 0.5 to about 15 wt. %, about 0.5 to about 10 wt. %, about 0.5 to about 8 wt. %, about 0.5 to about 6.0 wt. %, about 0.5 to about 4.0 wt. %, about 0.5 to about 3.0 wt. %, about 0.5 to about 2.5 wt. %, about 0.5 to about 2.0 wt. %, about 0.5 to about 1.5 wt. %, about 0.5 to about 1.25 wt. %, about 0.5 to about 1.0 wt. %; from about 1 to about 50 wt. %, about 1 to about 40 wt. %, about 1 to about 30 wt. %, about 1 to about 25 wt. %, about 1 to about 20 wt. %, about 1 to about 15 wt. %, about 1 to about 10 wt. %, about 1 to about 8 wt. %, about 1 to about 6.0 wt. %, about 1 to about 4.0 wt. %, about 1 to about 3.0 wt. %, about 1 to about 2.5 wt. %, about 1 to about 2.0 wt. %; about 5 to about 50 wt. %, about 5 to about 40 wt. %, about 5 to about 30 wt. %, about 5 to about 25 wt. %, about 5 to about 20 wt. %, about 5 to about 15 wt. %, about 5 to about 10 wt. %, or about 5 to about 8 wt. %, based on the total weight of the saffron beverage.

The one or more non-saffron juices, concentrates, or extracts thereof in the saffron beverage may be obtained from one or more of lemon, monk fruit, dandelion, passion fruit, pear, ginger, pomegranate, grape, apple, orange, grapefruit, banana, lime, peach, blue berries, strawberries, raspberries, black berries, cherries, watermelon, cantaloupe, or mixtures thereof. In some instances, the one or more non-saffron juices, concentrates, or extracts thereof are derived from at least one of passion fruit, pear, and ginger. In other instances, the one or more non-saffron juices, concentrates, or extracts thereof are derived from at least one of lemon, monk fruit, and dandelion. In further instances, the saffron beverages include at least one of cinnamon, nutmeg, guayusa, coco, milk, any known or to be developed plant based nut milk and coffee in amounts discussed above with regard to the non-saffron juices, concentrates, or extracts thereof.

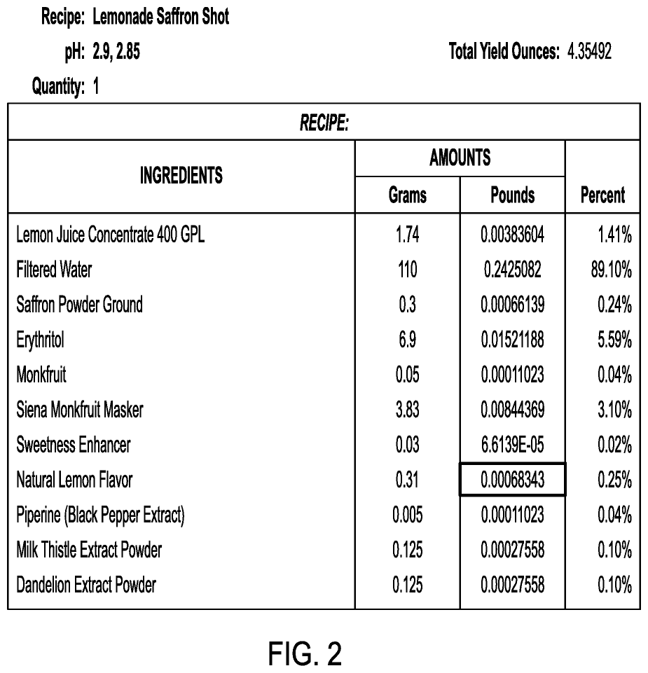

As illustrated by FIGS. 2-4, the saffron beverages may include at least two, at least three, at least four, or at least five non-saffron juices, concentrates, and/or extracts that provide, e.g., flavor to the saffron beverages. In at least one example embodiment, the saffron beverage includes non-saffron juices, concentrates, and/or extracts obtained from about 0.5 to about 20 wt. % of lemon; about 0.05 to about 20 wt. % of monk fruit; about 0.01 to about 2 wt. % of dandelion; and about 0.01 to about 2 wt. % of milk thistle. In at least one other example embodiment, the saffron beverage includes non-saffron juices, concentrates, and/or extracts obtained from about 5 to about 30 wt. % of passion fruit; about 1 to about 20 wt. % of pear; and about 0.01 to about 2 wt. % of ginger. In at least one further example embodiment, the saffron beverage includes non-saffron juices, concentrates, and/or extracts obtained from about 5 to about 30 wt. % of pomegranate; about 1 to about 20 wt. % of pear; about 0.01 to about 2 wt. % of cinnamon; and about 0.01 to about 1 wt. % of nutmeg.

The saffron beverages may include one or more sweeteners to increase the sweetness of the saffron beverage and/or enhance the flavor(s) of the saffron beverage. In some instances, the saffron beverage is free or essentially free of artificial sweeteners. In at least one instance, however, the saffron beverage includes one or more artificial sweeteners, such as aspartame, neotame, alitame, sodium saccharin, calcium saccharin, acesulfame potassium, sodium cyclamate, calcium cyclamate, neohesperidin dihydrochalcone, and/or sucralose.

The sweeteners employed in the saffron beverage may be caloric and/or non-caloric sweeteners. Examples of non-caloric sweeteners may include those selected from rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside M, rebaudioside N, rebaudioside O, dulcoside A, dulcoside B, rubusoside, stevia, stevioside, mogroside IV, mogroside V, rubusoside, products of rubusoside-transglucosylation reactions, Luo Han Guo sweetener, siamenoside, monatin, curculin, glycyrrhizic acid, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, steviolbioside, cyclocarioside, glycine, D-leucine, D-threonine, D-asparagine, D-phenylalanine, D-tryptophan, L-proline, salts thereof, and mixtures thereof. The saffron beverage may also include one or more sugar alcohol selected from erythritol, threitol, arabitol, Ribotol, xylitol, sorbitol, mannitol, dulcitol, lactitol, and mixtures thereof.

The saffron beverage has a pH of about 2 to about 5 to enhance the potency and benefits derived from consuming the saffron beverage. Preferably, the pH of the saffron beverage is from about 2.25 to about 4.5, preferably 2.5 to 4.0, and more preferably 2.75 to 3.5. In one instance, the saffron beverage has a pH of about 3.05 to about 3.1. In another instance, the saffron beverage has a pH of about 2.85 to about 2.9. In yet a further instance, the saffron beverage has a pH of about 3.25 to about 3.3.

To obtain a desired pH, the saffron beverage may include one or more pH adjusters. For example, one or more acids may be included to decrease the pH of the saffron beverage. Non-limiting examples of suitable acids for decreasing the pH of the saffron beverage include citric acid, acetic acid, and the like. The saffron beverage may also include one or more bases, such as sodium bicarbonate and the like, to decrease the pH of the saffron beverage. Additional or alternative acids and bases that are suitable for adjusting the pH of a beverage for human consumption are readily known to one of ordinary skill in the art.

The saffron beverage may optionally include preservatives. The saffron beverage may be free or essentially free of artificial preservatives. In at least one instance, the saffron beverage contains only or essentially only natural ingredients. As used herein, a natural ingredient is an ingredient that exists in nature or originates in nature.

In accordance with a further aspect of the disclosure, provided is a composition. The composition, in some instances, may be used to produce a saffron beverage. In at least one example embodiment, however, the composition may be consumed in a form that is not a beverage. The composition includes saffron and black pepper in the form of particles, extracts, and/or concentrates, which may be similar to the saffron and/or black pepper as described above. The composition may be formulated such that a beverage formed from the composition and water produces a saffron beverage as described herein. In some instances, the composition includes the components ingredients described above in amounts (weight percentages) that are about 3 to about 5 times as large as described above with respect to the saffron beverages to account for the lack of water.

For example, the composition may have saffron present in an amount of about 1 wt. %, about 5 wt. %, about 10 wt. %, about 15 wt. %, about 20 wt. %, about 25 wt. %, about 30 wt. %, about 35 wt. %, about 40 wt. %, about 45 wt. %, about 50 wt. % or more to about 99 wt. %, about 95 wt. %, about 90 wt. %, about 85 wt. %, about 80 wt. %, about 75 wt. %, about 70 wt. %, about 65 wt. %, about 60 wt. %, about 55 wt. %, about 50 wt. %, about 45 wt. %, about 40 wt. %, about 35 wt. % or less, including all ranges and sub-ranges therebetween, based on the total weight of the composition. The black pepper or an extract thereof in the composition may be in an amount from about 0.1 wt %, about 0.5 wt. %, about 1.0 wt. %, about 1.5 wt. %, about 2.0 wt. %, about 3.0 wt %, about 5 wt. %, about 10 wt. %, about 15 wt. %, about 20 wt. % or more to about 80 wt. %, about 70 wt. %, about 60 wt. %, about 50 wt. %, about 45 wt. %, about 40 wt. %, about 35 wt. %, about 30 wt. %, about 25 wt. %, about 20 wt. %, about 18 wt. %, about 16 wt. %, about 14 wt. %, about 12 wt. %, about 10 wt. % or less, including all ranges and sub-ranges therebetween, based on the total weight of the composition. The ratio of the amount of saffron to the amount of black pepper or an extract thereof in the composition may be substantially similar to or the same as the ratios described above with respect to saffron beverages.

The compositions may include non-saffron juices, concentrates, or extracts, such as those described above, in amounts of about 0.1% to about 98 wt. %. For example, the composition may have non-saffron juices, concentrates, or extracts present in an amount of about 0.1 wt. %, about 5 wt. c, about 10 wt. %, about 15 wt. %, about 20 wt. %, about 25 wt. %, about 30 w. %, about 35 wt. %, about 40 wt. %, about 45 wt. %, about 50 wt. % or more to about 99 wt. %, about 95 wt. %, about 90 wt. %, about 85 wt. %, about 80 wt. %, about 75 wt. %, about 70 wt. %, about 65 wt. %, about 60 wt. %, about 55 wt. %, about 50 wt. %, about 45 wt. %, about 40 wt. %, about 35 wt. %, about 30 wt. %, about 25 wt. %, about 20 wt. %, about 15 wt. % or less, including all ranges and sub-ranges therebetween, based on the total weight of the composition.

The composition may be anhydrous or essentially anhydrous. For example, the composition may have about 10 wt. % or less, about 8 wt. % or less, about 6 wt. % or less, about 4 wt. % or less, about 3 wt. % or less, about 2 wt. % or less, or about 1 wt. % or less of water.

According to another aspect of the disclosure, a method is provided for producing a saffron beverage. The method may include grinding stigmas of the saffron flower to obtain saffron particles for infusing the saffron beverage. Additionally and/or alternatively, concentrates and/or extracts of saffron may be obtained from saffron stigmas for infusing the saffron beverage. The particles, concentrate, and/or extracts for infusing saffron are mixed with black pepper and/or an extract thereof with a solvent to obtain a mixture. The mixture is preferably heated to a temperature of about 100° F. to about 200° F. and maintained at such temperature for at least one minute. In some instances, the mixture is heated to a temperature of more than 95° F., such as 100° F. or more, 110° F. or more, 120° F. or more, 130° F. or more, 140° F. or more, 150° F. or more, 160° F. or more, 170° F. or more, 180° F. or more, 190° F. or more, or 200° F. or more. The mixture may be maintained at the heated temperature for at least 5 minutes, at least 10 minutes, at least 30 minutes, at least 2 hours, at least 8 hours, or at least 24 hours. In some instances, the method for producing the saffron beverage includes shielding or preventing the mixture infused with saffron from receiving sunlight. Additionally, the method may include the step of bottling the saffron beverage within a bottle that inhibits light transmittance, such as a dark colored bottle (e.g., an amber or black pigmented bottle) or a bottle containing a UV and visible light blocking additives.

### EXAMPLES

The following examples are not intended to limit the invention, but are provided for purpose of elucidating the benefits of saffron beverages disclosed herein.

### Example 1

Disclosed are three non-limiting examples of saffron infused beverage formulations with a variety of ingredients and tastes. FIG. 2 is a formulation of one example saffron infused beverage, according to one aspect of the present disclosure.

Example formulation (composition or beverage composition) in FIG. 2 may be referred to as a lemonade saffron shot or royal bliss prepared based on a mix including, but not limited to, lemon juice (e.g., from 400 Gram Per Liter (GPL) concentrate) or any other fruit juice, filtered water, saffron powder ground (e.g., 30 milligrams, or 300 milligrams), erythritol, monkfruit, siena monkfruit masker, any known or to be developed sweetness enhancer, natural lemon flavor, peperine (form of a black pepper extract), milk thistle extract powder and dandelion extract powder. The lemonade saffron shot or royal bliss prepared based on a mix having 150 milligrams.

FIG. 2 provides example specifications, in terms of grams, pounds and percentage of the total yield ounce of a lemonade saffron shot with an example pH of from about 2.85 to 2.9. While FIG. 2 provides one example of the formulation of a lemonade saffron shot, inventive concepts are not limited to this exact specification in terms of grams, pounds and percentage and may vary.

Example benefits of a lemonade saffron shot of FIG. 2, which is one example of a saffron infused beverage, include, but are not limited to, liver detoxification, mood enhancement, mental clarity, increase in blood and air circulation in a human body, reduction in appetite and a rich source of antioxidant for cleansing.

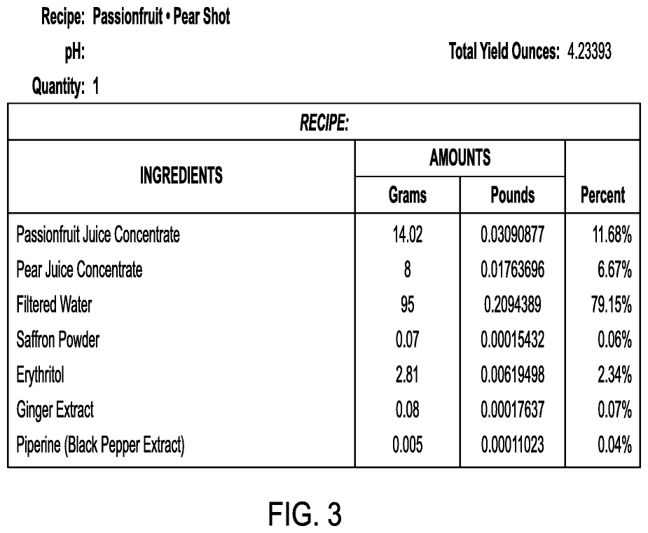

FIG. 3 is a formulation of another example saffron infused beverage, according to one aspect of the present disclosure.

Example formulation (composition or beverage composition) in FIG. 3 may be referred to as a passionfruit-pear shot or gold rush prepared based on a mix including, but not limited to, passionfruit juice concentrate, pear juice concentrate, filtered water, saffron powder (e.g., 7 milligrams), erythritol, ginger extract and peperine (form of a black pepper extract).

FIG. 3 provides example specifications, in terms of grams, pounds and percentage of the total yield ounce of a passionfruit-pear shot with an example pH of from about 3.05 to 3.10. While FIG. 3 provides one example of the formulation of a passionfruit-pear shot, inventive concepts are not limited to this exact specification in terms of grams, pounds and percentage and may vary.

Example benefits of a passionfruit-pear shot of FIG. 3, which is one example of a saffron infused beverage, include, but are not limited to, improved digestion, inflammation reduction, skin health improvement, mood enhancement, blood circulation and a rich source of antioxidants for cleansing.

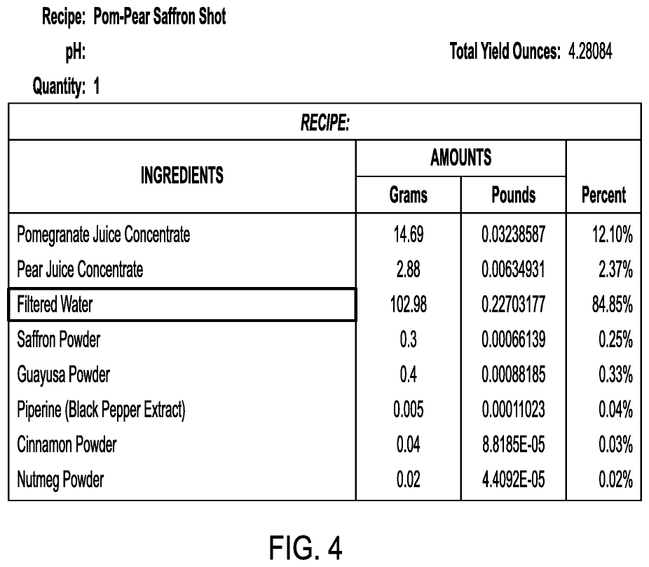

FIG. 4 is a formulation of yet a further example saffron infused beverage, according to one aspect of the present disclosure.

Example formulation (composition or beverage composition) in FIG. 4 may be referred to as a pom-pear saffron shot or red ecstacy prepared based on a mix including, but not limited to, pomegranate juice concentrate, pear juice concentrate, filtered water, saffron powder (e.g., 30 milligrams, or 300 milligrams), guayusa powder, peperine (form of a black pepper extract), cinnamon powder and nutmeg powder.

FIG. 4 provides example specifications, in terms of grams, pounds and percentage of the total yield ounce of a pom-pear saffron shot with an example pH of from about 3.25 to 3.30. While FIG. 4 provides one example of the formulation of a pom-pear saffron shot, inventive concepts are not limited to this exact specification in terms of grams, pounds and percentage and may vary.

Example benefits of a pom-pear saffron shot of FIG. 4, which is one example of a saffron infused beverage, include, but are not limited to, energy boost, increased focus sharpness, mood enhancement, blood circulation, reduction in appetite and a rich source of antioxidants for cleansing.

Amounts of each example ingredient in example beverage formulations of FIGS. 2-4, are for a specific total yield ounce of the corresponding beverage. Person having ordinary skill in the art would readily understand that should the total yield ounce change, the amounts and percentage of corresponding ingredients may also change, accordingly.

### Example 2

Saffron beverages were consumed along with alcoholic drinks to determine if the saffron beverages reduce the adverse effects of consuming alcohol. Two hundred and fifty people consumed alcoholic beverages along with saffron beverages over the period of an evening. Of the two hundred and fifty people, two hundred and thirty people (92%) reported reduced adverse effects of a hangover the next day. Two hundred and twenty people (88%) reported reduced downer effects associated with alcohol while consuming the alcoholic drinks and saffron beverages.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B. Other than in the operating examples, or where otherwise indicated, all numbers expressing quantities of ingredients and/or reaction conditions may be modified in all instances by the term “about,” meaning within +/−5% of the indicated number.

As used herein, all ranges provided are meant to include every specific range within, and combination of sub ranges between, the given ranges. Thus, a range from 1-5, includes specifically 1, 2, 3, 4 and 5, as well as sub ranges such as 2-5, 3-5, 2-3, 2-4, 1-4, etc. All ranges and values disclosed herein are inclusive and combinable. For examples, any value or point described herein that falls within a range described herein can serve as a minimum or maximum value to derive a sub-range, etc.

The term “essentially free” as used herein means that there is less than about 2% by weight of a specific ingredient added to the saffron beverage, based on the total weight of the saffron beverage. Nonetheless, the saffron beverage may include less than about 1 wt. %, less than about 0.5 wt. %, less than about 0.1 wt. %, or none of the specified ingredient. All of the ingredients set forth herein may be optionally included or excluded from the saffron beverages and/or methods of producing the same. When excluded, the saffron beverage may be free or essentially free of the ingredient.

What is claimed is:

1. A saffron beverage comprising:
(a) saffron particles in an amount of about 0.001 to about 1 wt. %, wherein the saffron particles have an average particle size of less than 2 mm;
(b) a black pepper extract in an amount of about 0.001 to about 1 wt. %; and
(c) water,
wherein the saffron beverage has a pH of about 2 to about 5 and all weight percentages are based on the total weight of the saffron beverage.

2. The saffron beverage of claim 1, wherein the saffron particles are derived from saffron flower stigmas.

3. The saffron beverage of claim 1, wherein the saffron particles are derived from a portion of the saffron flower stigmas extending from a middle portion to the end of the saffron flower stigmas.

4. The saffron beverage of claim 1, wherein the black pepper extract is piperine.

5. The saffron beverage of claim 1 further comprising one or more non-saffron juices, concentrates, or extracts thereof derived from at least one of lemon, monk fruit, dandelion, passion fruit, pear, ginger, pomegranate, grape, apple, orange, grapefruit, banana, lime, peach, blue berries, strawberries, raspberries, black berries, cherries, watermelon, cantaloupe, or mixtures thereof.

6. The saffron beverage of claim 5, wherein the one or more non-saffron juices, concentrates, or extracts thereof are derived from passion fruit, pear, and ginger.

7. The saffron beverage of claim 5, wherein the one or more non-saffron juices, concentrates, or extracts thereof are derived from lemon, monk fruit, and dandelion.

8. The saffron beverage of claim 1 further comprising at least one of cinnamon, nutmeg, and guayusa.

9. The saffron beverage of claim 1 further comprising at least one non-caloric sweetener selected from rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside M, rebaudioside N, rebaudioside O, dulcoside A, dulcoside B, rubusoside, stevia, stevioside, mogroside IV, mogroside V, rubusoside, products of rubusoside-transglucosylation reactions, Luo Han Guo sweetener, siamenoside, monatin, curculin, glycyrrhizic acid, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, steviolbioside, cyclocarioside, glycine, D-leucine, D-threonine, D-asparagine, D-phenylalanine, D-tryptophan, L-proline, salts thereof, and mixtures thereof.

10. The saffron beverage of claim 1 further comprising at least one sugar alcohol selected from erythritol, threitol, arabitol, Ribotol, xylitol, sorbitol, mannitol, dulcitol, lactitol, and mixtures thereof.

11. The saffron beverage of claim 1 being free of artificial sweeteners.

12. The saffron beverage of claim 1 being free of artificial preservatives.

13. The saffron beverage of claim 1 further comprising:
about 0.5 to about 20 wt. % of lemon
about 0.05 to about 20 wt. % of monk fruit;
about 0.01 to about 2 wt. % of dandelion; and
about 0.01 to about 2 wt. % of milk thistle.

14. The saffron beverage of claim 1 further comprising:
about 5 to about 30 wt. % of passion fruit;
about 1 to about 20 wt. % of pear; and
about 0.01 to about 2 wt. % of ginger.

15. The saffron beverage of claim 1 further comprising:
about 5 to about 30 wt. % of pomegranate;
about 1 to about 20 wt. % of pear;
about 0.01 to about 2 wt. % of cinnamon; and
about 0.01 to about 1 wt. % of nutmeg.

16. A saffron infused beverage comprising:
(a) about 0.001 to about 1 wt. % of a concentrate, extract, or mixture thereof derived from saffron stigmas;
(b) black pepper extract in an amount from about 0.001 to about 1 wt. %; and
(c) water,
wherein the beverage has a pH of about 2 to about 5, and wherein all weight percentages are based on the total weight of the saffron beverage.

17. The saffron infused beverage of claim 16, wherein the concentrate, extract, or mixture thereof derived from saffron stigmas comprises a plurality of saffron compounds including one or more compounds selected from crocetin, crocins, picrocrocins, safranal, and mixtures thereof.

18. A composition capable for use in a saffron beverage comprising:
(a) saffron particles in an amount of about 1 to about 90 wt. %; and
(b) a black pepper extract in an amount of about 0.1 to about 60 wt. %;
wherein the composition has less than 5 wt. % water and wherein all weight percentages are based on the total weight of the saffron beverage.
